(19) United States
(12) Patent Application Publication
(10) Pub. No.: US 2007/0118869 A1
(43) Pub. Date: May 24, 2007

(54) "Method and a system for controlling, navigating and managing data files, url's and other file system objects using code-based commands, in a computer system or an appliance enhanced by a computer system"

(76) Inventor: Ted Y. Lee, Sunnyvale, CA (US)

Correspondence Address: LADAS & PARRY, 5670 WILSHIRE BOULEVARD, SUITE 2100, LOS ANGELES, CA, 90036-5679, US

(21) Appl. No.: 10/582,430

(22) PCT Filed: Apr. 15, 2004
(86) PCT No.: PCT/IB04/01536

§ 371 Date: Jun. 9, 2006

(30) Foreign Application Priority Data
Dec. 9, 2003 (PH) 1-2003-000566

(51) Int. Cl. H04N 7/173; G06F 3/00; G06F 15/00; G06F 13/00; G06F 17/00; H04N 5/445

(52) U.S. Cl. 725/113; 725/112; 725/37; 715/501.1

(57) ABSTRACT

The present invention relates to a method and a system for controlling, navigating and managing data files, URL's and other file system objects using codebased commands in a computer system or a appliance enhanced by a computer system. The method and system operates under the control of an application system installed in the computer. Particularly, the computer system utilizes a recursive numbering menu system that simplifies and reduces the navigating process to merely pressing codes, or preferably numbers corresponding to the files or functions displayed in the menu and submenu, using a remote control, wireless keyboard or any device with key pads.

### FIELD OF THE INVENTION

The present invention relates in general to a computer system, but more particularly to a method and a system for controlling, navigating and managing data files, url's and other file system objects using code-based commands, particularly numbers, which is applicable to computers or computer-enhanced appliances,

### BACKGROUND OF THE INVENTION

Heretofore, computer systems utilize the popular Graphic User Interface (GUI), which uses the point-and-click navigation method and system, operated with the use of a mouse, trackball or touch pad. This method and system using these devices is inconvenient to the user because it requires the user to stay close to the display monitor when navigating, controlling and managing file system objects. This is not to mention that a keyboard is necessary to accomplish the same. Thus, information and applications are not easily accessible and navigated using the present system. It is also difficult for the user because it requires a certain amount of skill, effort and time to learn and adapt to their functions and operations. The present system requires a thorough study to operate and is not user-friendly. Furthermore, a dedicated display monitor is required for on-screen display of the file system objects.

### SUMMARY OF THE INVENTION

To overcome the aforesaid drawbacks of the present computer system, the present invention provides for a method and system in a computer system that simplifies the navigation, controlling and managing functions, which effectively makes information and applications easily accessible to users who need not go near to the display monitor to navigate, control and manage the same. The system readily makes data and application available to all (users/consumers) because of its simplified and centralized digital content menu system interface using code-based commands, particularly numbers.

It is, therefore, an object of the present invention to provide such a method and system in a computer system for navigating, controlling and managing data files, url's and other system file objects, that is easy to access, even from a distance, and intuitive for users of all ages.

More specifically, the object of the present invention is to provided a method and system in a computer system for navigating, controlling and managing data files, url's and other system file objects, which allow users to simply press the code, symbol or number which corresponds to a function, data file, hyperlink or other system file objects shown in the display monitor.

Another object of the present invention is to provide a method and system in a computer system for navigating, controlling and managing data files, url's and other system file objects, wherein the main user interface is designed to be built over Microsoft's Internet Explorer or other similar applications as a middleware, which graphic representation is aptly called TV User Interface or “TUI”, which makes use of the code, particularly numbers, to interface with a TV remote control or other devices with number key pads. This lessens the gap between Internet and television and may be considered a serious step towards the latter's full convergence with the former. However, the invention allows interface also with a wireless keyboard dedicated and provided therefor.

Yet, another object of the present invention is to provide for a method and system in a computer system, for navigating, controlling and managing data files, url's and other system file objects, which can boost, emulate and facilitate the integration of otherwise independent consumer appliances, functioning as an “infotainment” hub and/or internet appliance.

These and other objects and advantages of the present invention will become apparent upon a reading of the ensuing description taken in conjunction with the appended drawings.

### BRIEF DESCRIPTION OF THE DIFFERENT FIGURES OF THE DRAWINGS

FIG. 1 is a block diagram showing the computer system of the present invention;

FIG. 2a is a perspective view of the wireless keyboard of the computer system of the present invention;

FIG. 2b is a perspective view of the remote control of the present invention;

FIG. 3a is a screen diagram of the TV User Interface or “TUI” of the present invention which uses rectangular figures to represent each digital file in the file organizer;

FIG. 3b is a screen diagram of a third version of the TV User Interface or “TUI” of the present invention which uses circular figures to represent each digital file in the file organizer;

FIG. 3c is a screen diagram of the TV User Interface or “TUI” of the present invention which uses square figures to represent each digital file in the file organizer;

FIG. 4 is a screen diagram of a third version of the TV User Interface or “TUI” of the present invention which shows the multimedia key bar (MMK) activated;

FIG. 5 is a screen diagram of a third version of the TV User Interface or “TUI” of the present invention which shows the top task bar. (TTB) activated;”

FIG. 6 is a screen diagram of the TV User Interface or “TUI” showing the drop down menu or history containing a list of websites visited by user

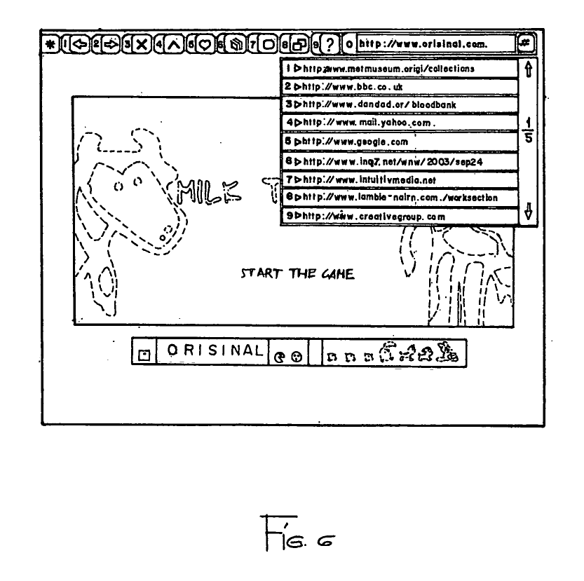

FIG. 7 is a screen diagram of a sample web page containing the Recursive Numbering Menu System of the present invention where web navigation is to be carried out;

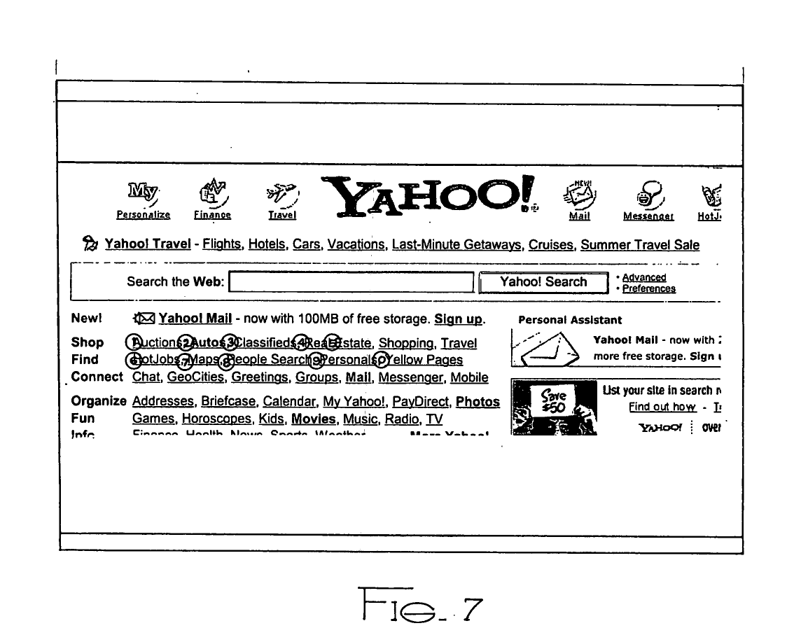

### BEST MODE FOR CARRYING OUT THE INVENTION

A computer system using code-based commands, particularly “numbers”, for controlling, navigating and managing data files, url's and other file system objects is provided. Consequently, the present computer system having a user, a digital content menu system, a plurality of file system objects, each file system object having a visual representation, and a method for controlling, managing and navigating the digital contents using number-based commands. Because the objects created according to the present invention are preferably implemented as files, the terms “file” and “object” is used interchangeably herein. It will be understood by one skilled in the art, however, that the present invention could be straightforwardly applied to objects having various other implementations.

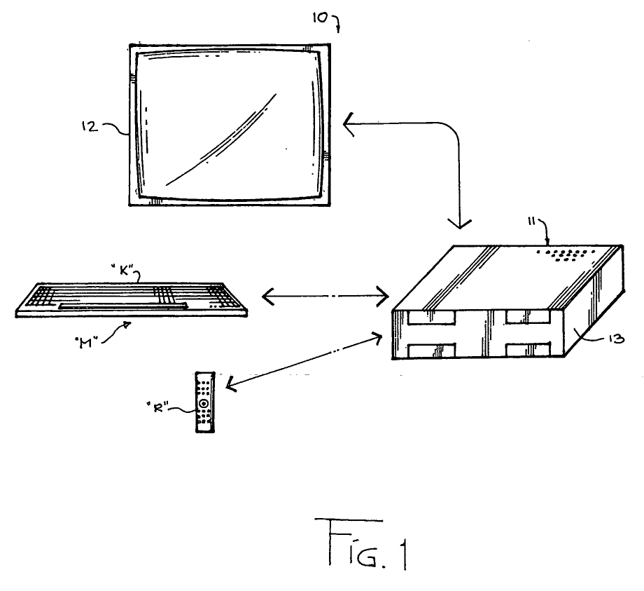

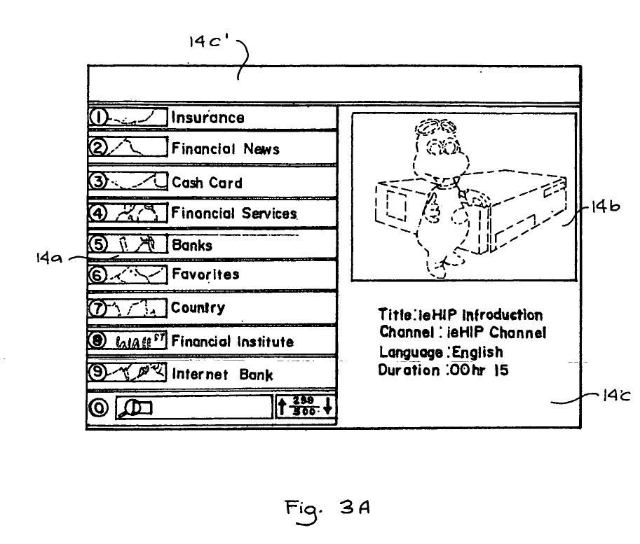

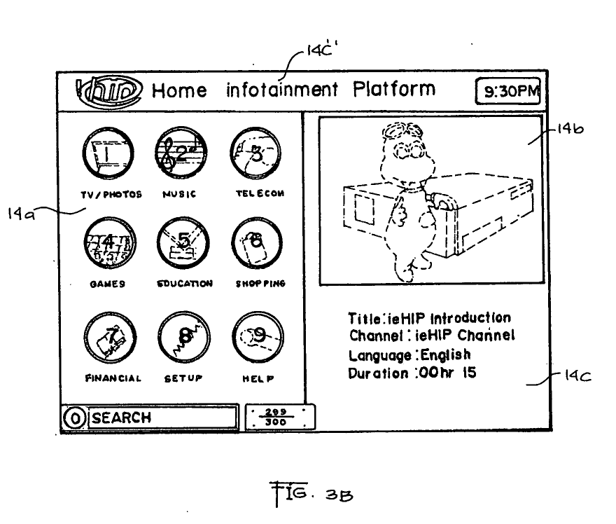

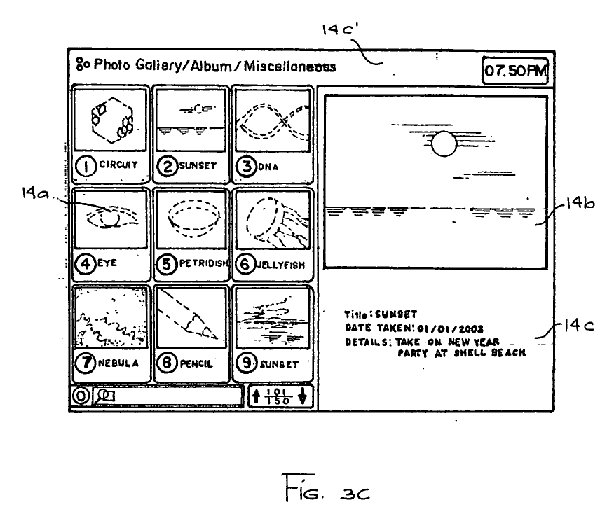

In a preferred embodiment of the present invention as shown in FIG. 1, the herein proposed computer system 10 using code-based commands comprises of a processing equipment 11, a displaying means 12 connected to the processing equipment 11, and interface command means “M” adapted to navigate, control and manage any desired data of file system objects such as, digital files, URL's, hyperlinks and the likes, through and from the processing equipment 11 while shown in an on-screen display in the display means 12 using code-based commands. It is preferred that the code-based commands feature numbers as shown in the screen diagram of the “TUI” and the sample web page, as shown in FIGS. 3a & 6, respectively.

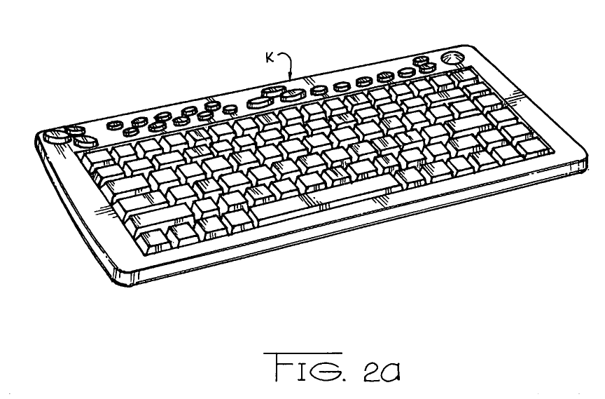

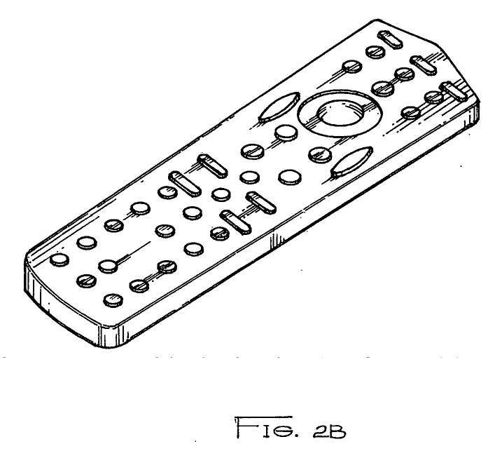

The code-based commands using numbers are specially programmed in navigating, controlling and managing the whole digital content of the herein computer system of the present invention. These commands are carried out using the interface command means “M” which may include a remote control “R” and wireless keyboard “K” as shown in FIGS. 2a and 2b (but other devices with a number key pad may be used). By simply pressing numbers corresponding to a function, data file, hyperlink and other system file objects, users can navigate, control and manage the same with ease. The commands may also be effective by voice of user with the use of a voice-activated means in the processing equipment, in which case, the user simply has to verbalize or articulate the number corresponding to the function, data file, hyperlink and other system file objects.

Applying and using numbers for the code-based commands, users can even do complicated function, such as managing movie and audio files, import and sort photos from digital cameras and portable storage media. The method involved is easy so user's don't need to learn new steps every time they import, export, delete, play, record and bookmark favorite URLs.

The processing equipment 11 consists of a main housing 13 connected to a conventional power source (not shown) and a circuit board provided within main housing 13. The circuit board further consisting of a computer-based program being integrated and interconnected to the electrical and electronic components thereof. The front panel of the processing equipment 11 has a multiple number of output and input connectors all being interconnected to the circuit board.

The display means 12, which is connected to the processing equipment 11 is a television (but it also be an LCD screen or computer monitor) which has full convergence with the internet.

The computer-based program which is loaded and integrated into the processing equipment 11 installs a centralized digital content menu system interface, which is graphically represented in the TV User Interface or “TUI”, which works using code-based commands consisting of codes with reference to file system objects (digital files, URLs, hyperlinks, etc.) stored in current and specified locations on said processing equipment 11. Moreover, the computer-based program is also capable of commanding the file system objects from the processing equipment and displaying on the screen of the display means 12 the desired file system objects. This is easily achieved by using the interface command means “M” with either the remote control “R”, the wireless keyboard “K” or other devices with key pads.

When the system is turned on, the display means 12 which is connected to the processing equipment 11 will immediately show the “TUI.” “TUI” primarily functions as a portal containing the pre-selected digital files shown in the file organizer area 14a of the “TUI,” each file corresponding to a particular number. The file organizer comprises several digital pages grouped into menu and sub-menu. For instance, the file organizer contains the following in the main menu: TV, iRADIO, MUSIC, PHOTO, MOVIE, GAME, TELCOM, NEWS, SHOPPING, EDUCATION, FINANCE, SPORTS, HEALTH, APPLICATION, WWW, WINDOWS, SEARCH ENGINE, etc. While, the following are contained in the sub-menu, “TV”: iTV, CABLE, DVD and DTV. And, then lastly, the following are contained in the second sub-menu, “CABLE:” LAST CHANNEL, CLOSED CAPTION, TELETEXT, CAPTURE STILL IMAGE, CHANNEL SURF, GUIDE and RECORD ORGANIZER.

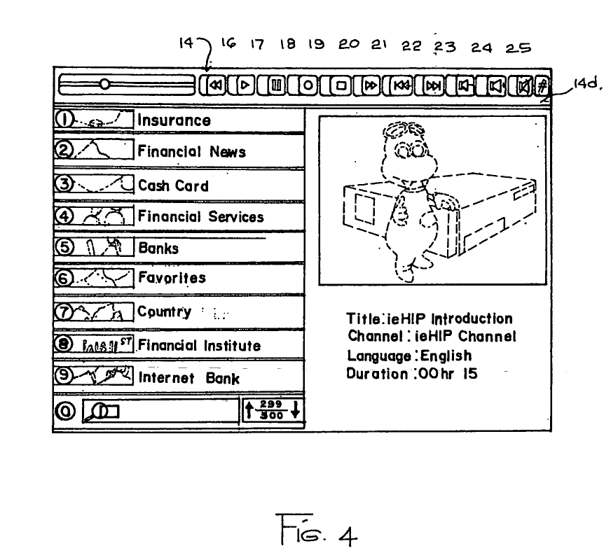

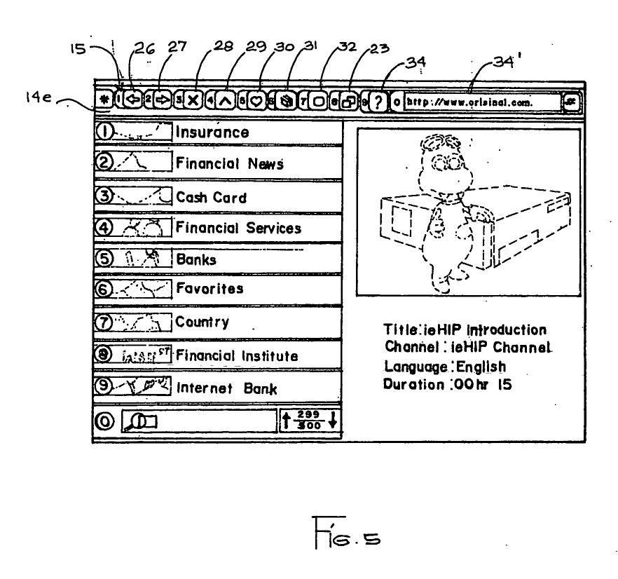

Beside the file organizer area 14a is a video area 14b and an information area 14c. The video area shows a preview of the files selected while the information area shows the detailed specifications of the said file. On the top portion of the “TUI” is a menu bar area 14d. By pressing the pound sign “#,” the multi media key bar (MMK) 14d will appear as shown in FIG. 4, while pressing on the asterisk sign “*,” the top task bar (TTB) 14e will appear as shown in FIG. 5.

As shown in FIG. 4, the different components and features of multimedia key bar (MMK) 14d are as follows: ?????? Help Icon 16 is used to view on-line help on the current open application. Window display icon 17 is used to maximize the current window. Previous icon 18 is used to view previous chapter/TV channel windows, while reversed icon 19 is used to view or rewind the current video picture or audio files. The record icon 20, play icon 21 and stop icon 22, records, starts or halts video/audio files, TV programs and the player activity. The pause icon 23 is used to freeze the current video/audio files. And the forward and next icons 24 and 25 are used to view advanced video files or listen to the advance track in audio files and view the next chapter/TV window, respectively.

As shown in FIG. 5, the different components and features of the top task bar (TTB) 15 are as follows: when the backward icon 26, which corresponds to number “1”, is activated, the current application is left running in minimized window while at the same time going back to the previous application; While activating the forward icon 27, which corresponds to number “2”, will end the current application and proceed to the next one; When the closed icon 28, which corresponds to number “3”, is activated, it terminates the current applications while allowing other active applications to maximize; the home icon 29, which corresponds to number “4”, will automatically lead the active application to the Main Menu (or HOME page) of the computer system; the favorite icon 30, which corresponds to number “5”, allows the viewing of all the favorite websites in the Internet explorer; the organizer icon 31, which corresponds to number “6” allows the user to organize and customize any content for each content page; the on-screen display icon 32, which corresponds to number “7”, allows the user to adjust parameters of the unit, e.g. microphone volume, magnifier and the like; the window display icon 33, which corresponds to number “8”, allows the user to adjust in scalable display window or in full screen; and the help icon 34, which corresponds to number “9”, is used to view on-line help on the current open application. At the right most portion of the TTB is an address bar 34, which corresponds to the number “0”, allows the user to surf the net by putting the address of the websites. If the user wishes to access files in the internet which do not form part of the pre-selected files, he/she simply has to press “0” and type into the space provided beside the address icon his/her desired URL.

To use the computer system of the present invention, the user will turn on the processing equipment and the display monitor. Immediately thereafter, the “TUI” will appear in the display means. By simply pressing the number corresponding to a particular digital file in the file organizer 14a, which runs for several pages. The user may also press the pound sign “#” to activate the multi media key bar (MMK) 14d which will appear in the menu bar area 14c as shown in FIG. 4, or press the asterisk sign “*” to activate the top task bar (TTB) 14e which will appear likewise in the menu bar area 14c as shown in FIG. 5. Thereafter, the user may press any number corresponding to a function in the multi media key bar (MMK) 14b and top task bar (TTB) to activate the particular desired function. For example, to add files into the organizer, the user will press the number corresponding to the organizer icon in the top task bar (TTB), then press the number corresponding to either of the following functions: add, delete, import, export, etc.

The user may also opt to go to the internet to access any digital file or url which is not part of the pre-selected set. By pressing “0” which corresponds to the address icon 34 of the top task bar (TTB), and typing into the space provided beside the address icon 34 the desired URL, the desired webpage will appear on-screen in the display means. Thereafter, all hyperlinks and functions in said web page will be automatically assigned a code or number. As such, the user can choose and access such links or functions in the web page by pressing the corresponding code or number. For the easy reference of the user, the websites visited will be recorded and retrieved by using the drop down menu and/or history. Each website appearing in the drop down menu and/or history is again assigned a code or number. Thus, the user merely has to press the number corresponding to the desired website to access the same.

While the invention has been described in detail with particular reference to the herein preferred embodiment thereof, it will be understood that variations and modifications can be effected within the spirit and scope of the present invention.

1. A system for controlling, navigating and managing data files, url's and other file system objects in a computer system or appliances enhanced by a computer system using code-based commands comprising:
a processing equipment consisting of a main housing connected to a main power switch, said main housing being provided with a user input, a program loaded into said housing, electronic control elements interconnected and integrated with said program on said main housing, with front panels being provided with output and input connectors;
a centralized digital content menu system interface being integrated on said processing equipment, the centralized digital content menu interface using code-based commands consisting of codes with reference to file system objects stored in current and specified locations on said processing equipment, wherein said file system objects are controlled, navigated and managed through said code-based commands;
a display monitor connected to said processing equipment; and
interface command means adapted to relay a desired file system object from said processing equipment by an on-screen display thereof on said display monitor using said code-based commands.

2. A computer system in accordance with claim 1, wherein the processing equipment is designed to be built over a middleware defined as a TV User Interface “TUI” which adopts the number-based interface of TV remote control.

3. A computer system in accordance with claim 1, wherein numbers define said code-based commands, called the recursive numbering system.

4. A computer system in accordance with claim 1, wherein a combination of numbers, numbers and alphabets or numbers, alphabets and symbols, define said code-based commands.

5. A computer system in accordance with claim 1, wherein said interface command means is any remote control device.

6. A computer system in accordance with claim 1, wherein said interface command means is a wireless keyboard.

7. A computer system in accordance with claim 1, wherein said interface command means is any device with a key pad.

8. A computer system in accordance with claim 1, wherein said interface command means is voice activated.

9. A computer system in accordance with claim 1, wherein said display monitor is a TV screen.

10. A computer system in accordance with claim 1, wherein said display monitor is an LCD (Liquid Crystal Display) screen.

11. A computer system in accordance with claim 1, wherein said display monitor is a PDA (Personal Digital Assistant).

12. A computer system in accordance with claim 1, wherein application program is capable of commanding file system objects from said processing equipment and displaying on the screen of said display monitor the desired file system objects.

13. A computer system in accordance with claim 1, wherein application program is capable of organizing file system objects, as well as adding or deleting file system objects in an organizer which functions as a portal.

14. A computer system in accordance with claim 1, wherein said file system objects consist of digital files, functions, hyperlinks and URLs.

15. A method in a computer system having a user, a processing system, a plurality of file system objects, each file system objects having a visual representation, the method for controlling, managing and navigating the whole digital contents of a computer system using number-based commands under the control of the processing system, the method comprising the steps of: the user will turn on the processing equipment and the display monitor. Immediately thereafter, the “TUI” will appear in the display means. “TUI” primarily functions as a portal containing the pre-selected digital files shown in the file organizer area 14a of the “TUI,” each file corresponding to a particular number. The file organizer may comprise of several digital pages. Beside the file organizer is a video area and an information area. The video area shows a preview of the files selected while the information area shows the detailed specifications of the said file. On the top portion of the “TUI” is a menu bar area. By pressing the pound sign “#,” the multi media key bar (MMK) will appear, while pressing on the asterisk sign “*,” the top task bar (TTB) will appear.
The user will simply press the number corresponding to a particular digital file in the file organizer, which runs for several pages. The user may also press the pound sign “#” to activate the multi media key bar (MMK) which will appear in the menu bar area as shown in FIG. 4, or press the asterisk sign “*” to activate the top task bar (TTB) which will appear likewise in the menu bar area. Thereafter, the user may press any number corresponding to a function in the multi media key bar (MMK) and top task bar (TTB) to activate the particular desired function. The user may also opt to go to the internet to access any digital file or url which is not part of the pre-selected set. By pressing “0” which corresponds to the address icon of the TTB, and typing into the space provided beside the address icon his/her desired URL, the desired webpage will appear on-screen in the display means. Thereafter, all hyperlinks and functions in said web page will be automatically assigned a code or number. As such, the user can choose and access such links or functions in the web page by pressing the corresponding code or number. For the easy reference of the user, the websites visited will be recorded and retrieved by using the drop down menu and/or history. Each website visited is again assigned a code or number. Thus, the user merely has to press the number corresponding to the desired website.
